(19) United States
(12) Patent Application Publication
(10) Pub. No.: US 2012/0188797 A1
(43) Pub. Date: Jul. 26, 2012

(54) SWITCHING POWER SOURCE APPARATUS

(75) Inventor: Ryouta NAKANISHI, Niiza-shi (JP)

(73) Assignee: Sanken Electric Co., Ltd., Niiza-shi (JP)

(21) Appl. No.: 13/347,861

(22) Filed: Jan. 11, 2012

(30) Foreign Application Priority Data
Jan. 24, 2011 (JP) 2011-011704

(51) Int. Cl. H02M 3/335

(52) U.S. Cl. 363/21.02

(57) ABSTRACT

A switching power source apparatus includes a first series circuit including a first switch element and a second switch element, a second series circuit including a resonant capacitor, a resonant reactor, and a primary winding of a transformer, a rectifying-smoothing circuit of a voltage of a secondary winding of the transformer, a controller of the first and second switch elements, a current detector detecting a current of the resonant capacitor Cri when the first switch element is ON, an integration circuit of the current of the current detector integrating the voltage signal over a period in which the voltage signal is equal to or greater than a first reference voltage, and an overcurrent protector of the first switch element if an output voltage of the integration circuit is equal to or greater than a second reference voltage.

### BACKGROUND OF THE INVENTION

1. Field of the Invention

The present invention relates to a half-wave current resonant switching power source apparatus having an overcurrent detection and protection circuit.

2. Description of Related Art

There are switching power source apparatuses having overcurrent detection and protection functions. For example, Japanese Unexamined Patent Application Publication No. H01-170369 (Patent Document 1) discloses a switching regulator having an overcurrent protection function. The switching regulator includes an overcurrent detector to detect a current passing through a switching element and an integration circuit to integrate switching pulses applied to a gate terminal of the switching element. If the overcurrent detector detects an overcurrent and if the integration circuit determines that the integral of switching pulses is out of an allowable range, the switching regulator activates a protection circuit.

To prevent an erroneous overcurrent protecting operation due to an instantaneous load variation, the switching regulator separates a charging path of the integration circuit from a discharging path thereof, thereby decreasing the sensitivity of the protection circuit and preventing the erroneous overcurrent protecting operation.

Japanese Unexamined Patent Application Publication No. H10-163836 (Patent Document 2) discloses a power source apparatus capable of preventing an erroneous overcurrent protecting operation that may occur due to external noise or internal current noise. The power source apparatus prohibits an overcurrent detecting operation carried out by an overcurrent detector during a period in which the overcurrent detector is not required to operate, such as an OFF period of a switching element, thereby preventing the erroneous overcurrent protecting operation due to noise.

FIG. 1 is a circuit diagram illustrating a half-wave current resonant circuit according to a related art. This circuit forms a current resonant switching power source apparatus having a half-wave rectifying circuit connected to a secondary winding Ns of a transformer T1. A DC power source Vi is connected to a series circuit including a high-side switching element Qh and a low-side switching element Q1. Each of the switching elements Qh and Ql is connected in parallel with a body diode. The low-side switching element Ql is connected in parallel with a voltage resonant capacitor Cry.

The low-side switching element Ql is also connected in parallel with a series resonant circuit including a reactor Lr, a primary winding Np (an exciting inductance Lp) of the transformer T1, and a resonant capacitor Cri.

The secondary winding Ns of the transformer T1 is connected in series with a diode RC and a smoothing capacitor Co that supplies smoothed DC power to a load Ro. The high- and low-side switching elements Qh and Ql may each be a MOSFET (Metal Oxide Semiconductor Field Effect Transistor) or an IGBT (Insulated Gate Bipolar Transistor).

The switching power source apparatus of FIG. 1 alternately turns on/off the switching elements Qh and Ql. When the switching element Qh is ON and the switching element Ql is OFF, the reactor Lr, the exciting inductance Lp of the primary winding Np, and the resonant capacitor Cri resonate to pass a resonant current from a positive electrode of the DC power source Vi to charge the resonant capacitor Cri.

When the switching element Qh turns off and the switching element Ql on, the charged resonant capacitor Cri applies a voltage to the primary winding Np of the transformer T1. This results in reversing voltages at ends of the primary winding Np and turning on the diode RC connected to the secondary winding Ns of the transformer T1.

Namely, the reactor Lr and resonant capacitor Cri resonate to supply a resonant current and transfer energy to the secondary winding Ns. The energy transferred to the secondary winding Ns is rectified through the diode RC and charges the smoothing capacitor Co, which supplies DC power to the load Ro.

The energy transferred to the secondary side of the transformer T1 is dependent on a charge level of the resonant capacitor Cri, and therefore, is adjustable by changing an ON period of the switching element Qh.

The energy transferred to the secondary side of the transformer T1 corresponds to a resonant current generated by the resonant capacitor Cri and reactor Lr. A period in which the energy is transferred to the secondary side of the transformer T1 is constant and is irrelevant to an ON period of the switching element Q1.

The half-wave current resonant circuit of FIG. 1 modulates the ON period of the switching element Qh according to an input voltage and load, thereby controlling an output voltage. At this time, the ON period of the switching element Ql is constant. If the resonant capacitor Cri is sufficiently large, energy accumulated in the resonant capacitor Cri is constant. Accordingly, a current passing through the primary side has a constant peak value (in an ideal state) without regard to an input voltage if load is unchanged. The half-wave current resonant circuit, therefore, detects an overcurrent by connecting a current detecting capacitor C1 in parallel with the resonant capacitor Cri, by passing a divided current through a detective resistor R1, by detecting a voltage Voc across the detective resistor R1, and by determining whether or not the detected voltage Voc is equal to or greater than a predetermined value.

### SUMMARY OF THE INVENTION

In practice, however, the peak of the current passing through the primary side varies depending on an input voltage. This is because of ripples that appear when the ON resistance of the switching elements or the resistance of the resonant capacitor Cri is small, or depending on line regulations.

FIG. 2 is a graph illustrating operating waveforms of the half-wave current resonant circuit of FIG. 1 with respect to different input voltages Vin supplied from the DC power source Vi. The waveforms illustrated in FIG. 2 include resonant current waveforms passing to the resonant capacitor Cri and voltage waveforms detected by the detective resistor R1. It is apparent in FIG. 2 that the peak of the detected voltage varies depending on the input voltage.

As illustrated in FIG. 2, the current passing through the resonant capacitor Cri has an AC waveform. The half-wave current resonant circuit of FIG. 1 detects an overcurrent by reading a peak value of the AC waveform. If the integration circuit of Patent Document 1 is connected to the detective resistor R1 of FIG. 1, the integration circuit detects the peak value because the integration circuit discharges in a negative period of the AC waveform. Accordingly, the value detected by the integration circuit varies depending on the input voltage, as illustrated in FIG. 2.

Although an error in the detected values, i.e., a difference between the peak values illustrated in FIG. 2 is small, it will cause a difference of several amperes in an output current on the secondary side of the transformer T1. This is a serious problem.

FIG. 3 is a circuit diagram illustrating the half-wave current resonant circuit of FIG. 1 additionally provided with a rectifying diode D1 and an integration circuit that includes a resistor R2 and a capacitor C2. The related arts of Patent Documents 1 and 2 employ a flyback forward system, and therefore, a current on a primary side does not become negative. With the rectifying diode D1, the half-wave current resonant circuit of FIG. 3 establishes the condition of not making a primary side current negative like the related arts of Patent Documents 1 and 2. Accordingly, the capacitor C2 of the integration circuit of FIG. 3 accumulates energy with a peak current.

The capacitor C2 of the integration circuit of FIG. 3 may be connected in parallel with a discharge resistor (not illustrated). If the resistance of the discharge resistor is large, the capacitor C2 is charged with a peak current so that a voltage across the capacitor C2 indicates a constant peak value. If the resistance of the discharge resistor is small to discharge the capacitor C2 every cycle, the voltage across the capacitor C2 will indicate a peak value that may change every cycle. In any case, the voltage across the capacitor C2 is unavoidably influenced by a peak value of a resonant current, to cause the problem of varying a detected overcurrent depending on an input voltage variation.

FIGS. 4A and 4B are waveform diagrams illustrating operating waveforms of the half-wave current resonant circuit of FIG. 3 when the input voltage Vin from the DC power source Vi varies. Waveforms of FIGS. 4A and 4B include a resonant current passing to the resonant capacitor Cri, a voltage Voc across the capacitor C2 of the integration circuit, and a voltage between an anode of the diode D1 and the ground, i.e., a voltage across the detective resistor R1.

The waveforms of FIG. 4A are obtained when the input voltage Vin is low and those of FIG. 4B are obtained when the input voltage Vin is high. In each case, the output load Ro is unchanged and only the input voltage Vin varies. It is understood from FIGS. 4A and 4B that the input voltage variations cause a difference in the voltage Voc to be detected. Namely, the voltage Voc detected when the input voltage Vin is low is lower than the voltage Voc detected when the input voltage Vin is high.

Due to the variation in the detected voltage Voc caused by variation in the input voltage Vin, the switching power source apparatus of FIG. 3 that detects an overcurrent based on the detected voltage Voc will suffer from the problem of varying a protection operating point of the overcurrent detector depending on variations in the input voltage Vin.

The related arts of Patent Documents 1 and 2 are designed in order to prevent an unwanted stoppage of operation due to a temporary overcurrent caused by noise or load variation. If these related arts are applied to a half-wave current resonant circuit, they will cause the same problem of varying a protection operating point of an overcurrent detector provided for the half-wave current resonant circuit.

The present invention provides a switching power source apparatus capable of properly detecting an overcurrent even if an input voltage varies.

According to an aspect of the present invention, the switching power source apparatus includes a first series circuit connected to both ends of a DC power source and including a first switch element and a second switch element, a second series circuit connected in parallel with the second switch element and including a resonant capacitor, a resonant reactor, and a primary winding of a transformer, a rectifying-smoothing circuit that rectifies and smoothes a voltage of a secondary winding of the transformer, a controller that alternately turns on/off the first and second switch elements according to an output voltage of the rectifying-smoothing circuit, a current detector that detects a current passing to the resonant capacitor when the first switch element is ON, an integrator that converts the current detected by the current detector into a voltage signal and integrates the voltage signal during a period in which the voltage signal is equal to or greater than a first reference voltage, and an overcurrent protector that compares an output voltage of the integration circuit with a second reference voltage, and if the output voltage of the integration circuit is equal to or greater than the second reference voltage, turns off the first switch element.

### BRIEF DESCRIPTION OF THE DRAWINGS

FIG. 1 is a circuit diagram illustrating a half-wave current resonant circuit according to a related art;

FIG. 2 is a waveform diagram illustrating operating waveforms of the related art of FIG. 1 when an input voltage varies;

FIG. 3 is a circuit diagram illustrating the half-wave current resonant circuit of FIG. 1 additionally provided with a rectifying diode to rectify a detected current and an integration circuit;

FIGS. 4A and 4B are waveform diagrams illustrating operating waveforms of the circuit of FIG. 3 with an input voltage changed to high and low;

FIG. 5 is a circuit diagram illustrating a switching power source apparatus according to Embodiment 1 of the present invention;

FIG. 6 is a waveform diagram illustrating operating waveforms of the apparatus of FIG. 5 with an input voltage changed to high and low;

FIG. 7 is a table listing output voltages of an integration circuit of the apparatus of FIG. 5 with a resistor R1 adjusted to different resistance values;

FIGS. 8A and 8B are waveform diagrams illustrating operating waveforms of the apparatus of FIG. 5 with an error of 0% with respect to input variations;

FIG. 9 is a waveform diagram illustrating operating waveforms of the apparatus of FIG. 5 with a first reference voltage set close to an upper limit;

FIG. 10 is a waveform diagram illustrating operating waveforms of the apparatus of FIG. 5 with the first reference voltage set close to a lower limit;

FIG. 11 is a circuit diagram illustrating a switching power source apparatus according to a modification of Embodiment 1 of the present invention;

FIGS. 12A and 12B are waveform diagrams illustrating operating waveforms of the apparatus of FIG. 11 with an error of 0% with respect to input variations;

FIG. 13 is a circuit diagram illustrating a switching power source apparatus according to another modification of Embodiment 1 of the present invention; and

FIGS. 14A and 14B are waveform diagrams illustrating operating waveforms of the apparatus of FIG. 13 with an error of 0% with respect to input variations.

### DESCRIPTION OF PREFERRED EMBODIMENTS

Switching power source apparatuses according to an embodiment and modifications of the present invention will be explained in detail with reference to the drawings.

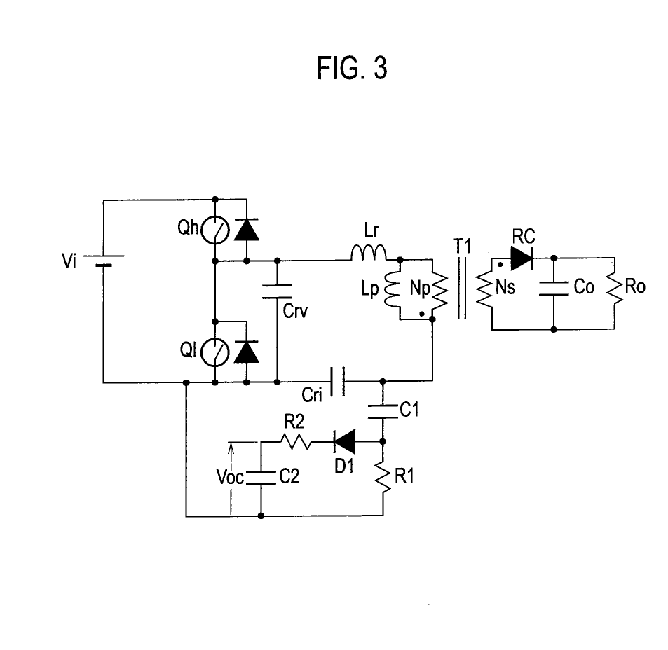

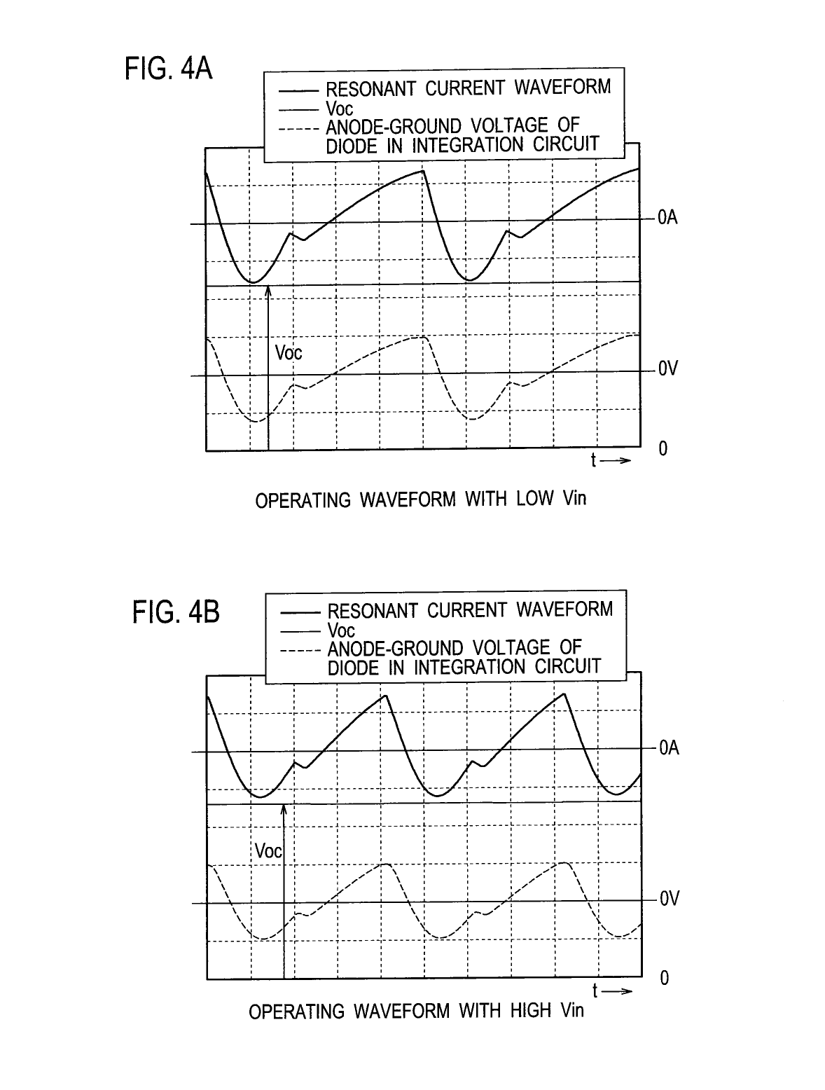

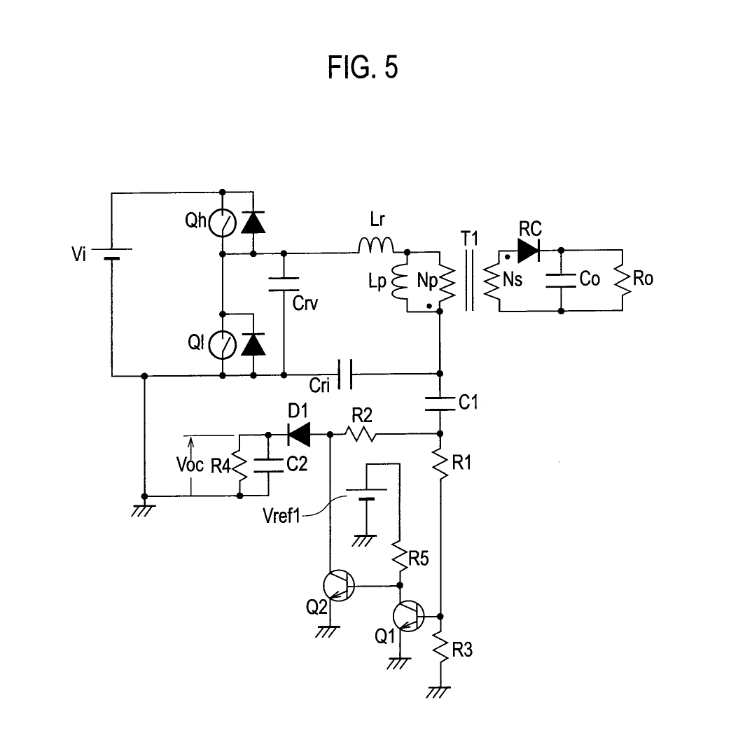

FIG. 5 is a circuit diagram illustrating a switching power source apparatus according to Embodiment 1 of the present invention. This is a current resonant switching power source apparatus with a half-wave rectifying circuit on a secondary side of a transformer T1. The apparatus of FIG. 5 differs from the apparatus of FIG. 3 in that the apparatus of FIG. 5 additionally has resistors R3, R4, and R5, a reference voltage Vref1, and switches Q1 and Q2. In FIG. 5, parts that are the same as or equivalent to those of FIG. 3 are represented with like reference marks.

In FIG. 5, a high-side switching element Qh corresponds to the first switch element as stipulated in the claims and a low-side switching element Ql to the second switch element. The switching elements Qh and Ql each are, for example, a MOSFET. The switching elements Qh and Ql are connected in series and are represented by the first series circuit as stipulated in the claims. The series circuit is connected to both ends of a DC power source Vi. The DC power source Vi is, for example, a power source that full-wave rectifies and smoothes commercial AC power and provides a DC voltage.

A resonant capacitor Cri, a resonant reactor Lr, and a primary winding Np of the transformer T1 are connected in series and are represented by the second series circuit as stipulated in the claims. The series circuit is connected in parallel with the switching element Ql. Also connected in parallel with the switching element Q1 is a voltage resonant capacitor Crv.

A diode RC and a smoothing capacitor Co are connected in series and are represented by the rectifying-smoothing circuit as stipulated in the claims. The series circuit is connected in parallel with a secondary winding Ns of the transformer T1, to rectify and smooth a voltage of the secondary winding Ns. The series circuit of the diode RC and capacitor Co operates as a half-wave rectifying-smoothing circuit. A DC voltage of the smoothing capacitor Co is an output voltage of the switching power source apparatus of FIG. 5 and is supplied to a load Ro connected in parallel with the smoothing capacitor Co.

The switching power source apparatus of FIG. 5 includes a controller (not illustrated). Based on the output voltage of the rectifying-smoothing circuit, i.e., the voltage applied to the load Ro, the controller alternately turns on/off the switching elements Qh and Ql in such a way as to keep the output voltage at a predetermined value.

A capacitor C1 and the resistors R1 and R3 are represented by the current detector as stipulated in the claims and detect a current passing through the resonant capacitor Cri when the switching element Qh is ON. The current appearing due to ON state of the switching element Qh is divided by the resonant capacitor Cri and capacitor C1. At this time, a current passing through the capacitor C1 is proportional to a current of the resonant capacitor Cri and also passes through the resistors R1 and R3.

The resistors R1, R2, R3, and R5, reference voltage Vref1, switches Q1 and Q2, diode D1, capacitor C2, and resistor R4 are represented by the integrator as stipulated in the claims. This integration circuit converts the current detected by the current detector into a voltage signal and integrates the voltage signal over a period in which the voltage signal is equal to or greater than a first reference voltage. The first reference voltage is preset by adjusting a ratio of the resistors R1 and R3 and is a voltage across a series circuit of the resistors R1 and R3 when the switch Q1 is changed from OFF to ON.

As mentioned above, the current passing through the capacitor C1 is converted by the resistors R1 and R3 into a voltage signal. If the voltage signal (a voltage across the series circuit of the resistors R1 and R3) is below the first reference voltage, the switch Q1 is OFF and the switch Q2 is ON with the base of the switch Q2 receiving the reference voltage Vref1. While the switch Q2 is ON, the resistor R2 is grounded through the switch Q2, and therefore, the voltage signal based on the current of the capacitor C1 is unable to charge the capacitor C2 through the resistor R2.

If the current of the capacitor C1 increases to increase the voltage signal from the resistors R1 and R3 equal to or greater than the first reference voltage, the switch Q1 turns on. This turns off the switch Q2, and therefore, the voltage signal starts to charge the capacitor C2 through the resistor R2. If the current of the capacitor C1 decreases to decrease the voltage signal from the resistors R1 and R3 below the first reference voltage, the switch Q1 turns off to again turn on the switch Q2 and stop charging the capacitor C2.

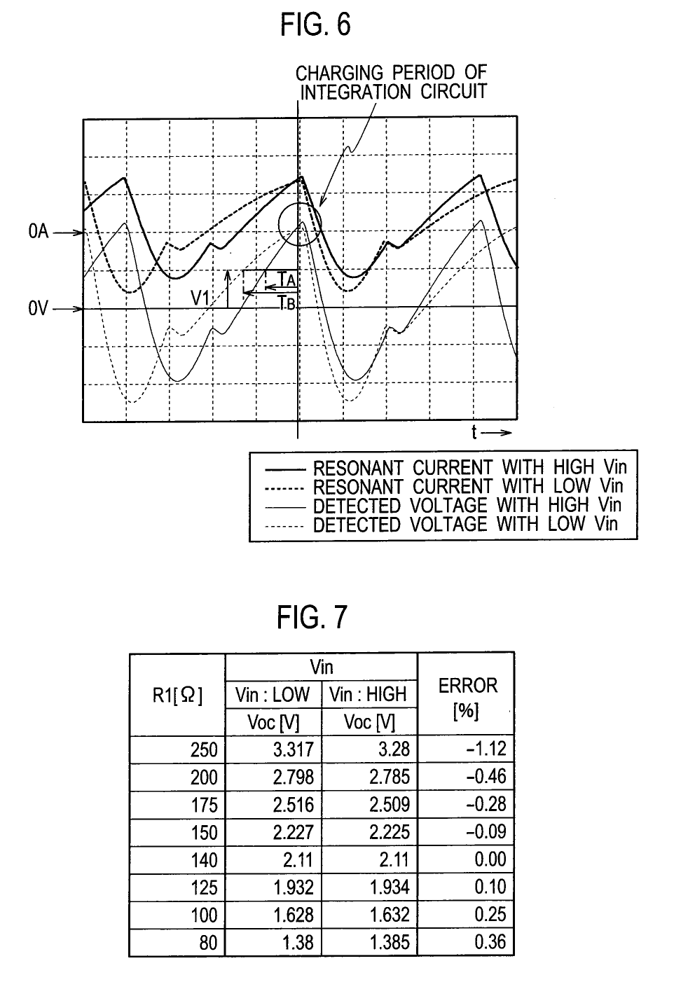

FIG. 6 is a waveform diagram illustrating operating waveforms of the switching power source apparatus of FIG. 5 with the input voltage Vin from the DC power source Vi changed to high and low. In FIG. 6, the first reference voltage is depicted by V1.

The integration circuit according to the related art of FIG. 3 charges the capacitor C2 during a peak period of a resonant current as indicated with a circle in FIG. 6. Namely, the related art carries out peak charging of the capacitor C2. In the peak period, there is only little difference between detected voltages with respect to the high and low input voltages, and therefore, the related art is unable to correct an overcurrent protection operating point with respect to the peak difference.

On the other hand, the switching power source apparatus of the present embodiment illustrated in FIG. 5 is capable of correcting the overcurrent protection operating point according to an input voltage. For this, the apparatus of the present embodiment utilizes that, as illustrated in FIG. 6, an interval TA between the first reference voltage V1 and a peak of a voltage detected when the input voltage Vin is high greatly differs from an interval TB between the first reference voltage V1 and a peak of a voltage detected when the input voltage Vin is low. Namely, the apparatus of the present embodiment charges the capacitor C2 of the integration circuit during a period in which a detected voltage from the series circuit of the resistors R1 and R3 is equal to or greater than the first reference voltage V1.

In this way, the integration circuit of the switching power source apparatus according to the present embodiment charges the capacitor C2 if the voltage across the series circuit of the resistors R1 and R3 is equal to or greater than the first reference voltage V1 as illustrated in FIG. 6.

In FIG. 6, a dotted waveform represents the voltage detected by the resistors R1 and R3 when the input voltage Vin is low and a continuous waveform represents the voltage detected by the resistors R1 and R3 when the input voltage Vin is high. Based on the first reference voltage V1, the capacitor C2 is charged for a longer period (TB) if the input voltage Vin is low and for a shorter period (TA) if the input voltage Vin is high. The longer the charging period, the larger the energy the capacitor C2 accumulates, and the shorter the charging period, the smaller the energy the capacitor C2 accumulates. The reference voltage V1 may be decreased to increase a difference in the energy accumulated in the capacitor C2 between the high and low input voltages and may be increased to decrease the difference.

Even if the input voltage Vin varies to vary the peaks of resonant current and detected voltage, the switching power source apparatus according to the present embodiment is able to adjust energy accumulated in the capacitor C2 by adjusting the first reference voltage V1. Namely, the apparatus of the present embodiment is capable of adjusting an overcurrent protection operating point according to an input voltage. For example, the apparatus of the present embodiment can adjust the first reference voltage V1 so that the capacitor C2 may accumulate the same energy without regard to the input voltage Vin and so that an overcurrent is properly detected even if the input voltage Vin varies.

Although not illustrated in FIG. 5, the switching power source apparatus of FIG. 5 includes an overcurrent protector. The overcurrent protector compares the output voltage Voc of the integration circuit with a second reference voltage, and if the output voltage Voc is equal to or greater than the second reference voltage, turns off the switching element Qh. The second reference voltage is preset in the overcurrent protector. The second reference voltage is so set that, if an overcurrent passes as a resonant current, the voltage Voc across the resistor R4 exceeds the second reference voltage.

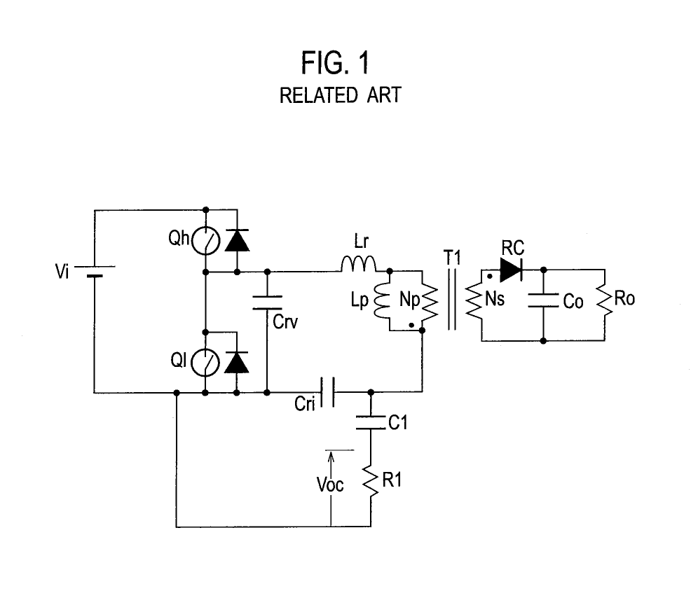

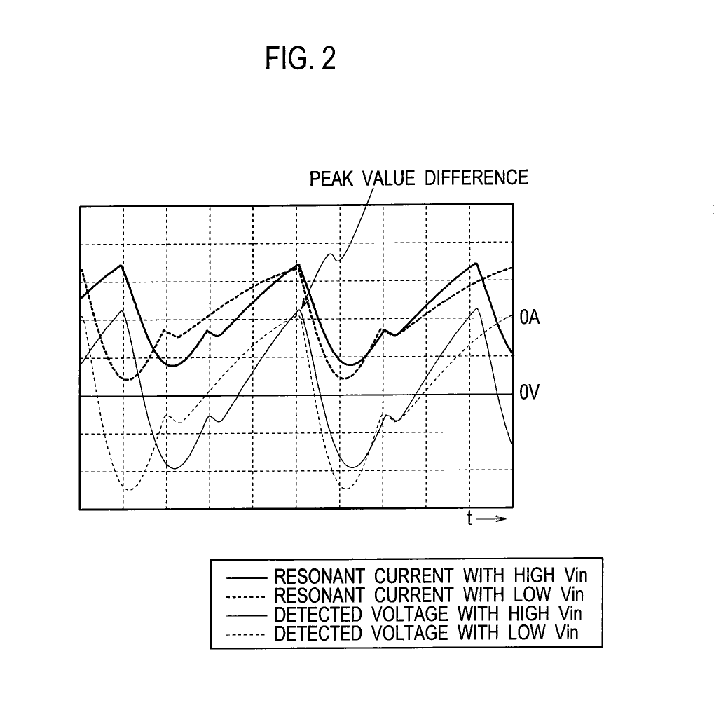

The remaining configuration of the switching power source apparatus of FIG. 5 is the same as that of the related art illustrated in FIGS. 1 and 3, and therefore, overlapping explanations are omitted.

Operation of the switching power source apparatus according to Embodiment 1 of the present invention will be explained. A normal operation without overcurrent of the apparatus is the same as that of the related art explained with reference to FIGS. 1 and 3. If an overcurrent occurs due to a circuit abnormality such as a short circuit of the load Ro, a detected voltage across the series circuit of the resistors R1 and R3 becomes equal to or greater than the first reference voltage V1, to increase a voltage Voc of the capacitor C2. By the use of the voltage Voc, the overcurrent protector of the switching power source apparatus detects the overcurrent. The switching power source apparatus according to the present embodiment has such a simple configuration as illustrated in FIG. 5 to detect an overcurrent and correct an overcurrent protection operating point of the overcurrent protector according to an input voltage.

FIG. 7 is a table listing output voltages (Voc) of the integration circuit of FIG. 5 with the resistor R1 adjusted to different resistance values. Values in the table of FIG. 7 are obtained by simulating the circuit of FIG. 5 with the resistor R2 of 330Ω, the resistor R3 of 100Ω, the capacitor C2 of 0.1 μF, and the resistor R4 of 10 kΩ.

When the resistor R1 is set to 140Ω, the output voltage Voc is unchanged with respect to high and low input voltages Vin, to provide an error of 0%. Since the output voltage Voc of the integration circuit with the resistor R1 set to 140Ω is unchanged irrespective of whether the input voltage Vin is high or low, the overcurrent protector in the switching power source apparatus according to the present embodiment is able to properly detect an overcurrent according to the output voltage Voc.

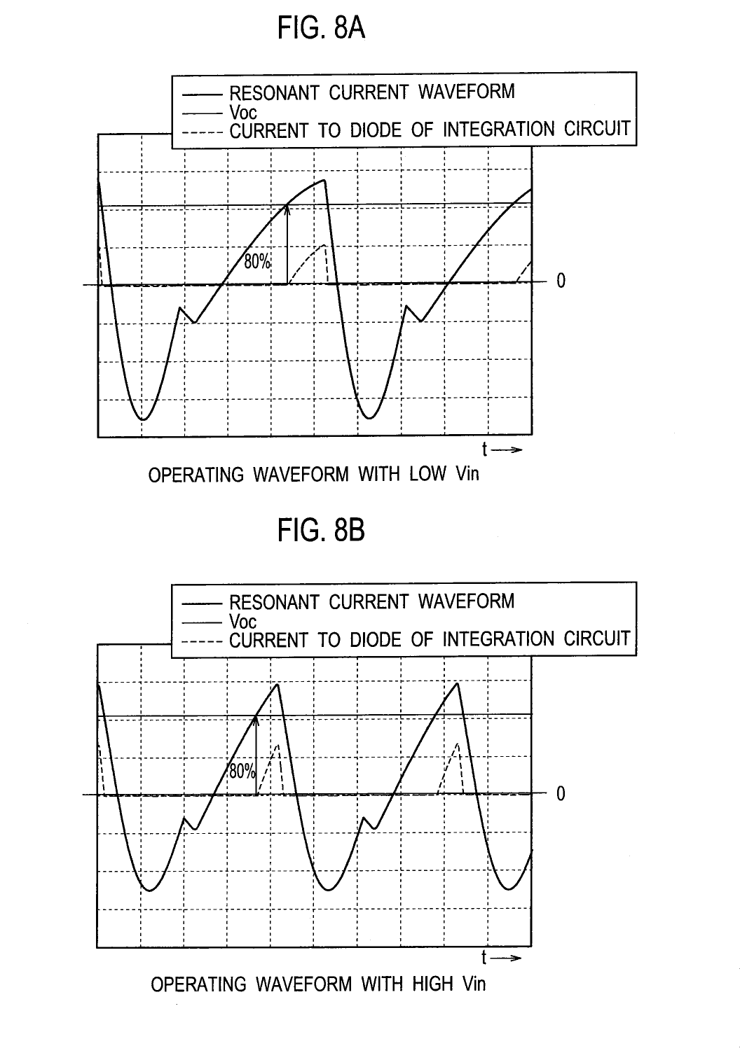

FIGS. 8A and 8B are waveform diagrams illustrating operating waveforms of the apparatus of FIG. 5 with an error of 0% (the resistor R1 set to 140Ω) with respect to input voltage variations. FIG. 8A is an operating waveform with the input voltage Vin being low and FIG. 8B is an operating waveform with the input voltage Vin being high. In FIGS. 8A and 8B, a thick continuous line represents a resonant current waveform, a thin continuous line the output voltage Voc of the integration circuit, and a thin dotted line a current passing through the diode D1.

As is apparent in FIGS. 8A and 8B, the output voltage Voc of the integration circuit is unchanged irrespective of whether the input voltage Vin is high or low. This means that Embodiment 1 is capable of properly correcting an overcurrent protection operating point of the overcurrent protector with respect to variations in the input voltage Vin. In the examples of FIGS. 8A and 8B in which the output voltage Voc is the same without regard to the input voltage Vin, the integration circuit integrates a portion above an 80% value of the current passed to the diode D1 with a 100% value being between zero and a peak of the current.

The first reference voltage V1 may be expressed with a percentage with respect to a maximum of the voltage signal across the series circuit of the resistors R1 and R3. In this case, the first reference voltage V1 that keeps the output voltage Voc of the integration circuit constant without regard to the input voltage Vin has an upper limit and a lower limit, although these limits change depending on the resistance values of the resistors R1 and R3.

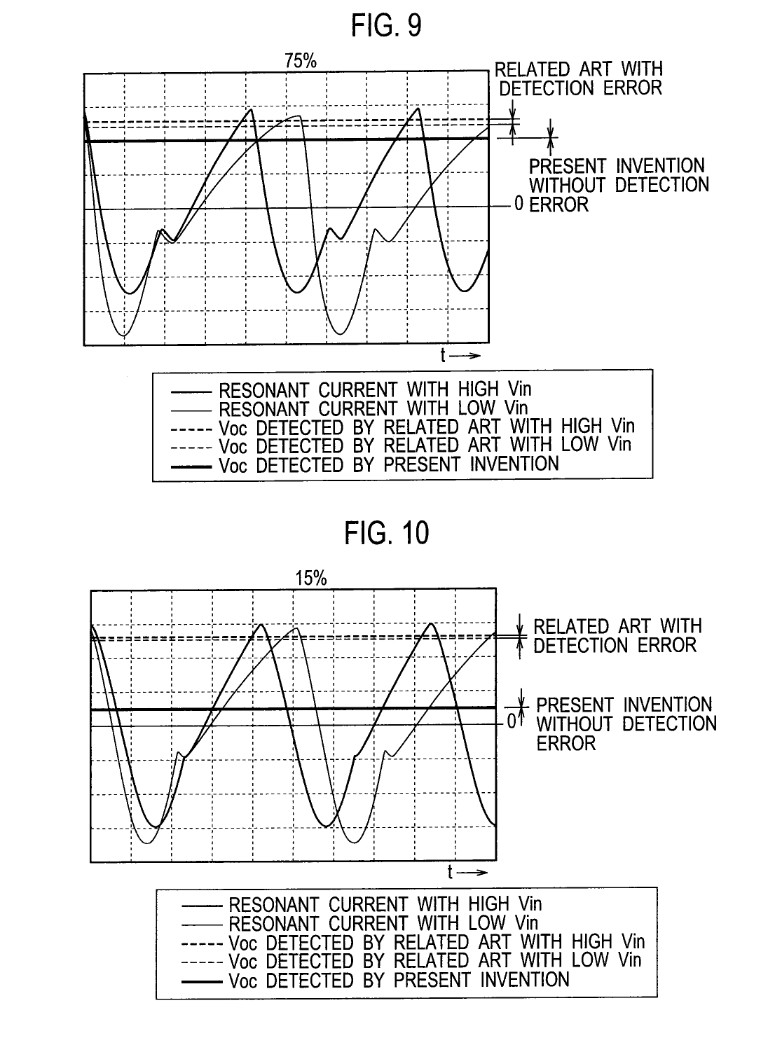

FIG. 9 is a waveform diagram illustrating operating waveforms of the apparatus of FIG. 5 with the first reference voltage V1 set close to the upper limit. The waveforms illustrated in FIG. 9 include resonant current waveforms with the input voltage Vin being high and low and output voltage waveforms (Voc) according to the related art and Embodiment 1 of the present invention. In FIG. 9, the first reference voltage V1 is set to 75% of a peak of the voltage signal provided by the series circuit of the resistors R1 and R3.

In FIG. 9, the related art causes a difference in the output voltage Voc between when the input voltage Vin is high and when the input voltage Vin is low. On the other hand, the switching power source apparatus according to the present embodiment causes no difference in the output voltage Voc irrespective of variations in the input voltage Vin.

FIG. 10 is a waveform diagram illustrating operating waveforms of the apparatus of FIG. 5 with the first reference voltage V1 set close to the lower limit. Namely, the first reference voltage V1 is set to 15% of a peak of the voltage signal provided by the series circuit of the resistors R1 and R3.

In FIG. 10, the related art causes a difference in the output voltage Voc between when the input voltage Vin is high and when the input voltage Vin is low. On the other hand, the switching power source apparatus according to the present embodiment causes no difference in the output voltage Voc irrespective of variations in the input voltage Vin.

As mentioned above, the first reference voltage V1 may optionally be set according to the resistance values of the resistors used to detect a current, to keep the output voltage Voc of the integration circuit constant without regard to whether the input voltage Vin is high or low. The first reference voltage V1, however, has upper and lower limits. If the first reference voltage V1 is set to a value out of the range between the upper and lower limits, the overcurrent protection operating point of the overcurrent protector will not properly be corrected.

The first reference voltage V1 is related to a time constant of the integration circuit, in particular, the resistance of the resistor R4 and influences the output voltage Voc of the integration circuit. If the first reference voltage V1 is set to be lower than the lower limit, the output voltage Voc will decrease, and if it is set to be higher than the upper limit, the output voltage Voc will approach the value detected by the related art (peak value).

Even if the first reference voltage V1 is set to a value out of the range between the upper and lower limits, it is not always impossible to correct the overcurrent protection operating point of the overcurrent protector. If proper resistors are used to detect an overcurrent in the switching power source apparatus of the present embodiment, the first reference voltage V1 that keeps the output voltage Voc of the integration circuit unchanged irrespective of variations in the input voltage Vin is considered to be a voltage within the range of 15% to 80% of the peak value of a voltage signal provided by the series circuit of the resistors R1 and R3.

In this way, the switching power source apparatus according to the present embodiment of the present invention is capable of properly detecting an overcurrent even if the input voltage Vin varies.

The switching power source apparatus according to Embodiment 1 of the present invention has the integrator that integrates a voltage signal in a period in which the voltage signal is equal to or greater than the first reference voltage, thereby adjusting the charge timing of the capacitor C2. The first reference voltage V1 is preset to a proper value to properly detect an overcurrent without regard to input voltage variations that may vary a peak value of the voltage signal. This is particularly useful when the present invention is applied to a half-wave current resonant circuit that contains a resonant capacitor to pass a current having an AC waveform.

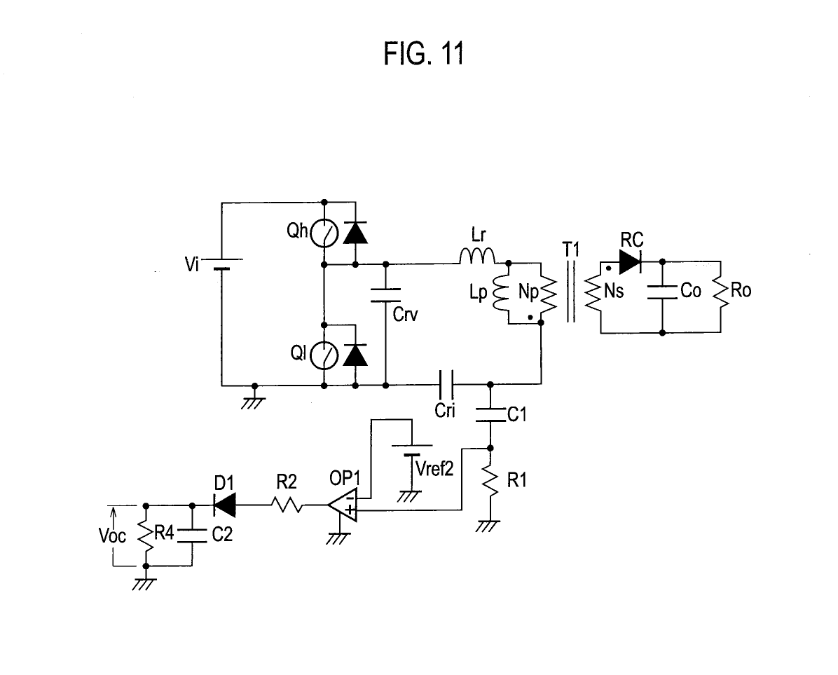

FIG. 11 is a circuit diagram illustrating a switching power source apparatus according to a modification of Embodiment 1 of the present invention. What is different from the switching power source apparatus of FIG. 5 is that the apparatus of FIG. 11 has an integrator including resistors R1, R2, and R4, a reference voltage Vref2, an operational amplifier OP1, a diode D1, and a capacitor C2. Like the integrator of FIG. 5, the integrator of FIG. 11 converts a current detected by a current detector into a voltage signal and integrates the voltage signal during a period in which the voltage signal is equal to or greater than a first reference voltage. The operational amplifier OP1 multiplies a difference between the voltage signal and the reference voltage Vref2 by a gain and outputs the resultant product. The first reference voltage is preset by adjusting the reference voltage Vref2.

In FIG. 11, a current passing through a capacitor C1 is converted by the resistor R1 into the voltage signal. If the voltage signal (a voltage across the resistor R1) is lower than the first reference voltage (reference voltage Vref2), the operational amplifier OP1 outputs no voltage, and therefore, the capacitor C2 is not charged.

If a current passing through the capacitor C1 increases to increase the voltage signal from the resistor R1 equal to or greater than the first reference voltage (reference voltage Vref2), the operational amplifier OP1 multiplies a difference between the voltage signal and the reference voltage Vref2 by the gain and outputs the resultant product, which passes through the resistor R2 and charges the capacitor C2. If the current passing through the capacitor C1 decreases, the charging of the capacitor C2 stops.

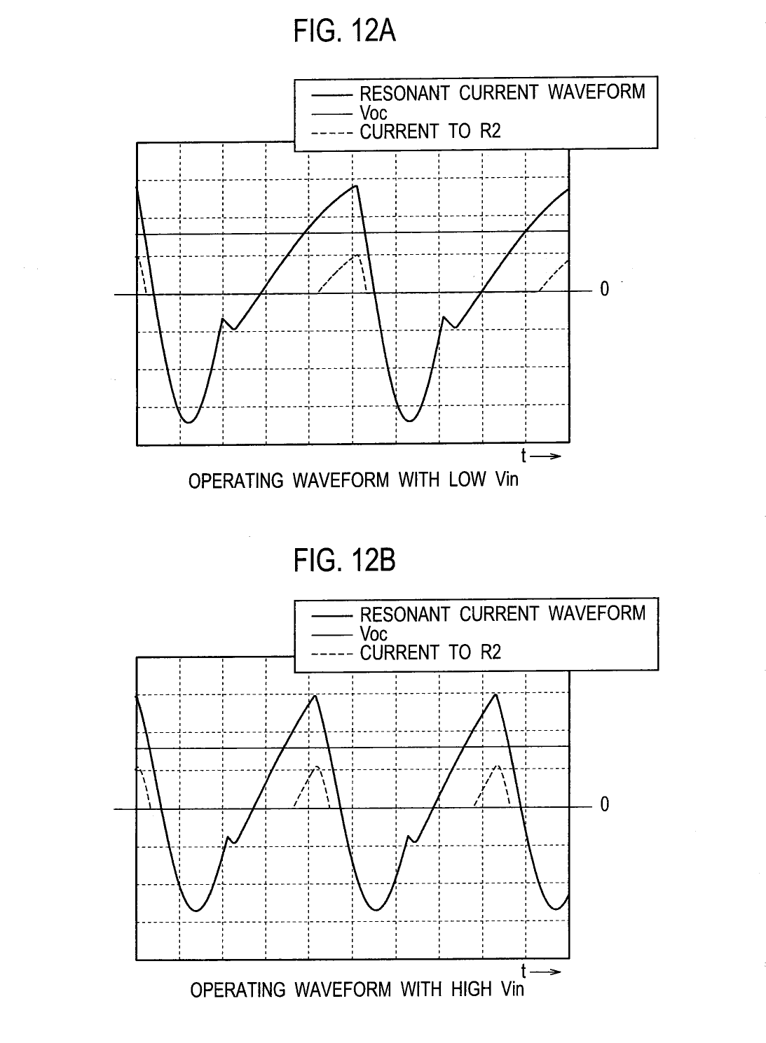

FIGS. 12A and 12B are waveform diagrams illustrating operating waveforms of the apparatus of FIG. 11 with an error of 0% in an output voltage Vout of the integrator with respect to variations in an input voltage Vin. The waveforms of FIG. 12A are obtained when the input voltage Vin is low and those of FIG. 12B are obtained when the input voltage Vin is high. In FIGS. 12A and 12B, a thick continuous line represents a resonant current waveform, a thin continuous line represents the output voltage Voc of the integrator, and a thin dotted line represents a current passing through the resistor R2.

As is apparent in FIGS. 12A and 12B, the output voltage Voc of the integrator is unchanged between when the input voltage Vin is low and when the input voltage Vin is high. This means that an overcurrent protection operating point of an overcurrent protector (not illustrated) installed in the apparatus of FIG. 11 is properly corrected with respect to variations in the input voltage Vin.

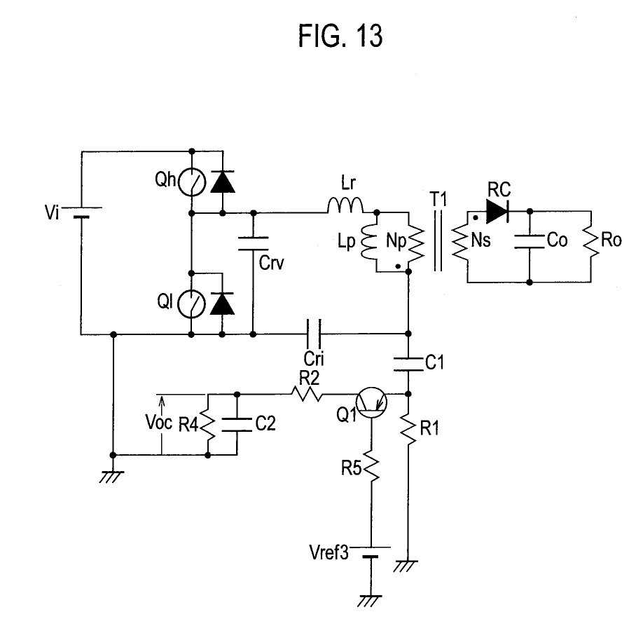

FIG. 13 is a circuit diagram illustrating a switching power source apparatus according to another modification of Embodiment 1 of the present invention. What is different from the switching power source apparatus of FIG. 5 is that the apparatus of FIG. 13 has an integrator including resistors R1, R2, R4, and R5, a reference voltage Vref3, a switch Q1, and a capacitor C2. Like the integrator of FIG. 5, the integrator of FIG. 13 converts a current detected by a current detector into a voltage signal and integrates the voltage signal over a period in which the voltage signal is equal to or greater than a first reference voltage. The first reference voltage is preset by adjusting the reference voltage Vref3.

In FIG. 13, a current passing through a capacitor C1 is converted by the resistor R1 into the voltage signal. If the voltage signal (a voltage across the resistor R1) is lower than the first reference voltage (reference voltage Vref3), the switch Q1 is OFF not to charge the capacitor C2.

If the current passing through the capacitor C1 increases and if the voltage signal from the resistor R1 becomes equal to or greater than the first reference voltage (reference voltage Vref3), the switch Q1 becomes conductive to charge the capacitor C2. If the current passing through the capacitor C1 decreases, the charging of the capacitor C2 stops.

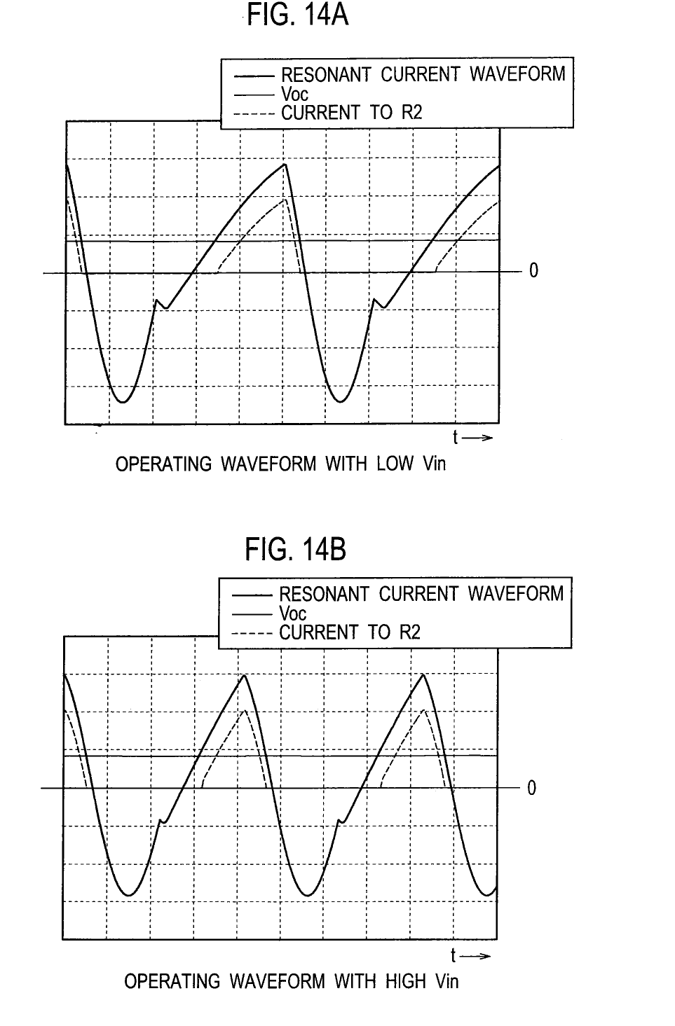

FIGS. 14A and 14B are waveform diagrams illustrating operating waveforms of the apparatus of FIG. 13 with an error of 0% in an output voltage Vout of the integrator with respect to variations in an input voltage Vin. The waveforms of FIG. 14A are obtained when the input voltage Vin is low and those of FIG. 14B are obtained when the input voltage Vin is high. In FIGS. 14A and 14B, a thick continuous line represents a resonant current waveform, a thin continuous line represents the output voltage Voc of the integrator, and a thin dotted line represents a current passing through the resistor R2.

As is apparent in FIGS. 14A and 14B, the output voltage Voc of the integration circuit is unchanged between when the input voltage Vin is low and when the input voltage Vin is high. This means that an overcurrent protection operating point of an overcurrent protector (not illustrated) installed in the apparatus of FIG. 13 is properly corrected with respect to variations in the input voltage Vin.

In this way, the switching power source apparatus according to the present invention is capable of correcting input voltage variations and properly detecting an overcurrent.

The present invention is applicable to half-wave current resonant switching power source apparatuses having overcurrent detecting and protecting circuits and the switching power source apparatuses according to the present invention are applicable to electric equipment.

This application claims benefit of priority under 35USC §119 to Japanese Patent Application No. 2011-011704, filed on Jan. 24, 2011, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A switching power source apparatus comprising:
a first series circuit of a first switch element and a second switch element connected to both ends of a DC power source;
a second series circuit of a resonant capacitor, a resonant reactor, and a primary winding of a transformer, the second series circuit being connected in parallel with the second switch element;
a rectifying-smoothing circuit configured to rectify and smooth a voltage of a secondary winding of the transformer;
a controller configured to alternately turn on/off the first and second switch elements according to an output voltage of the rectifying-smoothing circuit;
a current detector configured to detect a current passing through the resonant capacitor when the first switch element is ON;
an integrator configured to convert the current detected by the current detector into a voltage signal and integrate the voltage signal over a period in which the voltage signal is equal to or greater than a first reference voltage; and
an overcurrent protector configured to compare an output voltage of the integrator with a second reference voltage and to turn off the first switch element if the output voltage of the integration circuit is equal to or greater than the second reference voltage.

2. The apparatus of claim 1, wherein the rectifying-smoothing circuit is a half-wave rectifying-smoothing circuit.

3. The apparatus of claim 2, wherein the first reference voltage is set to be equal to or greater than 15% of a maximum of the voltage signal.

4. The apparatus of claim 1, wherein the first reference voltage is set to be equal to or lower than 80% of a maximum of the voltage signal.
